(19) United States
(12) Patent Application Publication
(10) Pub. No.: US 2025/0363568 A1
(43) Pub. Date: Nov. 27, 2025

(54) ELECTRONIC GROUP CREATION BASED ON IPUT IMAGE

(71) Applicant: MOTOROLA MOBILITY LLC, WILMINGTON, DE (US)

(72) Inventors: AMIT KUMAR AGRAWAL, BANGALORE (IN); PANDURANGA REDDY PAILLA, NALGONDA (IN); VIJAYPRAKASH IDLUR, IDLUR (IN)

(21) Appl. No.: 18/673,177

(22) Filed: May 23, 2024

(51) Int. Cl. G06Q 50/00; G06F 21/32; G06V 40/16

(52) U.S. Cl. CPC G06Q 50/01; G06F 21/32; G06V 40/172; G06V 40/179

(57) ABSTRACT

A method provides techniques for implementing image-based group creation (IBGC) on the electronic device. An image of a group of people is obtained. The image can be obtained via a camera on the electronic device, and/or retrieved from a repository of previously acquired images. Faces are detected for people in the images. Identities of the people are obtained based on the detected faces. Metadata for the identified people is obtained. The metadata can include contact information, role information, and so on. A group including two or more people is created, and stored in memory of the electronic device. A group registration portal is created, and access to the group registration portal is sent to the group members to enable the members to activate their membership in the group.

### BACKGROUND

### 1. Technical Field

The present disclosure generally relates to portable electronic devices, and more specifically to portable electronic devices that enable creation of electronic online groups.

### 2. Description of the Related Art

Online groups, such as forums, social media groups, and online communities, can be highly useful for a variety of purposes. Online groups provide a platform for individuals to share information, ideas, and experiences on specific topics of interest. The topics can be academic, professional, recreational, and others. The sharing of information amongst group members can lead to valuable insights and knowledge exchange. Additionally, online groups can serve as support networks where members can seek advice, share challenges, and receive emotional support from others facing similar situations. Another benefit of online groups is facilitating networking and connections with like-minded individuals, professionals, or potential collaborators, which can lead to new opportunities and collaborations. Moreover, online groups often provide opportunities for learning and skill development through discussions, tutorials, and sharing of resources. Many online groups have members with specialized knowledge or expertise in certain areas, providing a valuable resource for seeking advice or guidance. Furthermore, online groups can help build a sense of community and belonging among members, fostering relationships and social interactions. Overall, online groups can be a powerful tool for learning, networking, support, and collaboration, providing a range of benefits to individuals and communities alike.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement an image-based group creation (IBGC) feature, according to one or more embodiments;

FIG. 2 is an example illustration of an electronic device transmitting a request for group creation to an application computer system, according to one or more embodiments;

FIG. 3 depicts an exemplary user interface for initiating image-based group creation, according to one or more embodiments;

FIG. 4A depicts an exemplary image used for creating an image-based group, according to one or more embodiments;

FIG. 4B depicts a modified version of the exemplary image of FIG. 4A with facial bounding boxes applied to each person within the image, according to one or more embodiments;

FIG. 4C depicts another modified version of the exemplary image of FIG. 4A with name tagging applied to identify the individual persons within the image, according to one or more embodiments;

FIG. 5 illustrates an exemplary group creation user-interface, according to one or more embodiments;

FIG. 6 illustrates exemplary group member data records for individuals within an electronically-created group, according to one or more embodiments;

FIG. 7 illustrates an exemplary group registration portal user interface, according to one or more embodiments;

FIG. 8 illustrates an exemplary user interface for intra-group communication, according to one or more embodiments;

FIG. 9 depicts a flowchart of a computer-implemented method for image-based group creation, according to one or more embodiments; and

FIG. 10 depicts a flowchart of a computer-implemented method for autonomously selecting group members to complete image-based group creation, according to one or more embodiments.

### DETAILED DESCRIPTION

According to aspects of the present disclosure, an electronic device, a method, and a computer program product provide techniques for implementing image-based group creation (IBGC) on the electronic device. According to aspects of the disclosure, an image of a group of people is obtained. The image can be obtained via a camera on the electronic device and/or retrieved from a repository of previously-acquired images. Faces are autonomously detected for people in the images, and identities of the people are obtained, based on the detected faces, using computer-based facial recognition techniques. Metadata for the identified people is obtained. The metadata can include contact information, role information, and so on. A group that includes two or more people is created and stored in memory of the electronic device, or in a database, remote storage, or other suitable location. A group registration portal is created, and access to the group registration portal is sent to the group members to enable the members to activate their membership in the group.

Online groups can be useful for a wide variety of purposes. However, the process of creating a group can be tedious. Manually entering group member contact information for creation of the group can be inconvenient and time consuming. For example, manually entering each contact's name, phone number, relationship(s), and other details can be time-consuming, especially if there is a large number of contacts to enter. Additionally, the manual entry process can be error-prone. There is a higher chance of making errors, such as typographical errors in phone numbers or misspelled names, when entering contact information manually. Moreover, some mobile devices, such as smartphones, have limited screen area and/or limited input options, which can make it challenging to enter contact information accurately and efficiently.

The disclosed embodiments alleviate the aforementioned issues that can occur when creating an online group. Disclosed embodiments enable rapid online group creation from an image. The group is initially created with two or more members based on an image that includes a group of people. Faces are identified in the image, and identities of two or more people in the image are obtained from a repository of known contacts, based on the faces that are identified. Embodiments enable a quick group creation that includes all of the people in an image. Alternatively, embodiments enable customization of the group members, in which case one or more people in the image may be added to, or excluded from, the group.

According to one or more embodiments, when a user wishes to create a group, an image can be obtained from a camera of an electronic device at the time of group creation. Alternatively, an image can be obtained from an album of previously acquired images. The album can be stored on the electronic device and/or stored remotely, such as on a cloud-based storage system.

Additionally, in one or more embodiments, a role of each group member is automatically established based on obtained metadata for each group member. In one or more embodiments, the metadata can come from stored contacts, social media profiles, and/or other suitable sources. As an example, for a family group, roles can include brother, sister, aunt, uncle, cousin, and so on.

According to one or more embodiments, a group registration portal is created and shared with each member of the group. The group members can then log in to the group registration portal to activate their group membership. In one or more embodiments, the group members have the capability to edit, add, and/or delete some or all of the metadata that pertains to them. The feature of image-based group creation gives benefits of quickly and efficiently creating online groups. These, and other advantages of disclosed embodiments, are further explained in the following detailed description.

One or more embodiments can include an electronic device including: at least one output device, including a display; a communication system; a memory having stored thereon an image-based group creation (IBGC) module; and at least one processor communicatively coupled to the display, the communication system, and the memory. The at least one processor executes program code of the IBGC module and configures the electronic device to: present a group creation user-interface on the display, where the group creation user-interface enables the processor to receive group entry criteria; obtain an image comprising a plurality of persons; detect a face for at least two people among the plurality of persons; identify each of the at least two people, based on the detected face; obtain metadata for each identified person of the at least two people, where the metadata includes contact information; determine a group role for each identified person, in part based on the metadata obtained for the identified person; create a group comprising two or more persons from the plurality of persons and assign a corresponding group role to each of the at least two people identified; store the group in the memory of the electronic device and/or a remote server that manages the group; and create a group registration portal.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

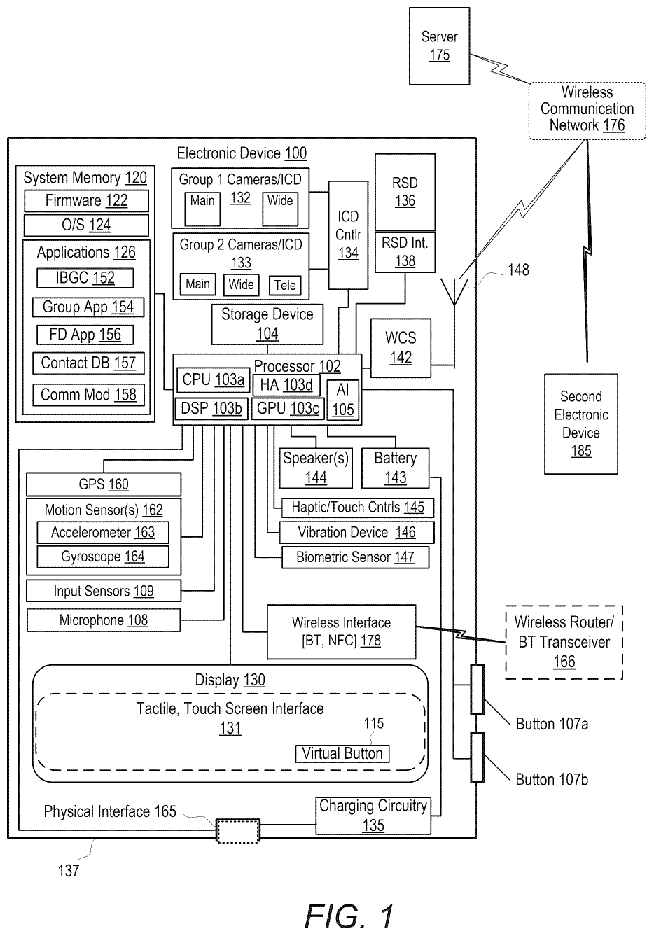

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide image-based group creation functions, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, IBGC module 152, Group app 154, Face Detection (FD) app 156, contact database 157, and communication module 158. Other applications may also be present. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, IBGC module 152 can include program instructions for implementing features of disclosed embodiments. Group app 154 can include program instructions for managing the creation of groups, communication between group members, managing group notifications, and/or other group features. Face detection application 156 can contain program instructions/code that cause the processor 102 to identify one or more faces in an acquired image. Contact database 157 can store metadata pertaining to known contacts. The metadata can include, but is not limited to, an image including the face of a contact, a name of the contact, one or more user identifiers pertaining to the contact, one or more aliases (nicknames) pertaining to the contact, telephone number(s) for the contact, email address(es) for the contact, a relationship for the contact (friend, coworker, spouse, sibling, cousin, etc.), a mailing address for the contact, and so on. In one or more embodiments, data within contact database 157 is used for performing functions of identifying faces in an image and associating the identified faces with data from the contact database 157 for the purposes of image-based group creation.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, which can be similarly connected to wireless communication network 176. In one or more embodiments, various functions that are being performed on communications device 100 can be supported using or completed via/on server 175. In one or more embodiments, server 175 can store images, group member information, group communication, and/or other associated data for the creation and/or use of online groups.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communication interface(s) of electronic device 100.

Second electronic device 185 may correspond to a known contact stored within electronic device 100. As an example, second electronic device 185 may be associated with a friend or relative of the user of electronic device 100. Accordingly, in one or more embodiments, electronic device 100 may send a notification to second electronic device 185 providing information about an online group created using image-based group creation techniques of disclosed embodiments. The notification can provide access, via the second electronic device 185, to a group registration portal, using contact information from contact database 157.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

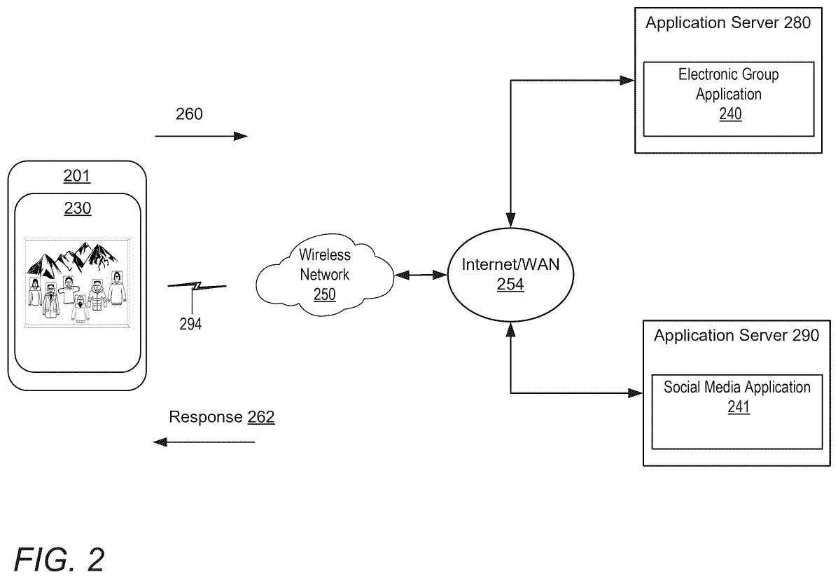

FIG. 2 is an example illustration of an electronic device transmitting a request for group creation to an application computer system, such as application server 280, and receiving a response from the application computer system indicating group creation, according to one or more embodiments. Device 201 includes a display 230 on which group creation information is displayed. Device 201 can be an implementation of electronic device 100, having similar components and/or functionality. As indicated previously, in one or more embodiments, at least some of the group creation and/or management functions may be implemented on a network-accessible application server, such as indicated by application server 280. Application server 280 is communicatively coupled to Internet/WAN 254. In one or more embodiments, Internet/WAN 254 can include one or more wide area networks (WANs) and/or the Internet. In one or more embodiments, electronic device 201 can communicate wirelessly with wireless network 250 via transmissions of communication signals 294 to and from network communication devices, such as base stations or cellular nodes, that can include components of network 250. Network 250 enables exchange of data between electronic device 201 and application server 280, via Internet/WAN 254.

Application server 280 can host electronic group application 240. The electronic group application 240 can utilize account data obtained from device 201 and/or social media application 241 hosted on application server 290. The application server 280 and application server 290 may communicate with each other via Internet/WAN 254.

In one or more embodiments, the request 260 and response 262 may utilize Hypertext Transfer Protocol (HTTP) and/or its secure counterpart HTTPS. Embodiments may use RESTful APIs, JavaScript Object Notation (JSON), Simple Object Access Protocol (SOAP), and/or other communication techniques for exchanging information.

In one or more embodiments, in order to support scalability and/or case of maintenance, application servers 280 and 290 may be implemented via virtualization, such as utilizing hypervisors like VMware, Hyper-V, or KVM. One or more embodiments may include containerization services such as docker, LXC, or other suitable container framework to enable multiple isolated user-space instances. Additionally, one or more embodiments may include load balancing and/or orchestration, such as utilizing Kubernetes, or other suitable orchestration framework.

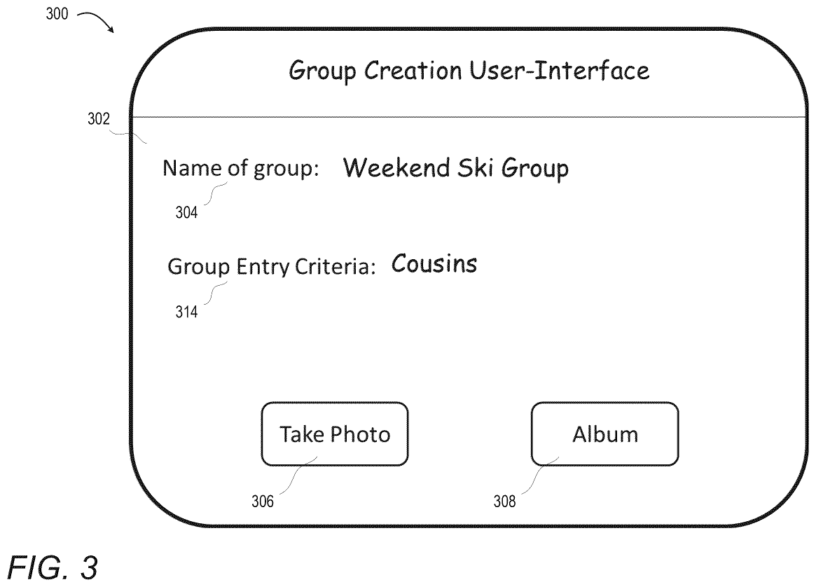

FIG. 3 depicts an exemplary user interface 300 for initiating image-based group creation, according to one or more embodiments. In one or more embodiments, the user interface shown in FIG. 3 may be rendered on a display 302 of a device such as device 100 of FIG. 1. The user interface 300 includes a group name field 304, where a name for a new group is entered or specified. The user interface 300 can further include a group entry criteria field 314, where one or more group entry criterion can be entered or specified. The group entry criteria can include a relationship, such as a family relationship (e.g., siblings), a professional relationship (e.g., direct reports), and/or other suitable criteria. In one or more embodiments, the criteria are used for filtering people to include within a group during the group creation process. The filtering can include using acquired metadata to determine if a person in an image should be included or excluded from a group. For example, if creating a group of ‘cousins’ from a group image that includes four cousins and two friends, the two friends can be excluded based on associated metadata from contact records and/or social media platforms that establishes the friends as friends (and not cousins).

The user interface 300 may further include a take photo button 306. The take photo button 306, when invoked (e.g., via tap, click, etc.) causes a processor of the electronic device to activate the ICD controller 134 which selects one of the ICDs, such as cameras 132 and/or cameras 133 as shown in FIG. 1 and presents a preview of an image to be captured. In one or more embodiments, a front facing camera is selected as the default camera, but can be changed by the user or by the ICD controller based on adjustments, such as zoom or other operations, performed prior to capturing the image. Once the user selects the capture image function within the generated image capture UI, the ICD controller performs the capture and the processor thus acquires an image from a camera within the electronic device. Thus, in one or more embodiments, obtaining the image comprises obtaining the image from an image capture device. The user interface 300 may further include an album button 308. The album button 308, when invoked (e.g., via tap, click, etc.) causes a processor of the electronic device to open available storage of albums or galleries of captured or downloaded images and enables the user to acquire an image from a storage location, such as on-device storage, and/or remote storage. Thus, in one or more embodiments, obtaining the image comprises obtaining the image from a storage location that contains previously acquired images. The storage location can include a storage location on the electronic device and/or can include a location on an accessible online storage. The obtained image can include two or more people that can be included in the group that is being created.

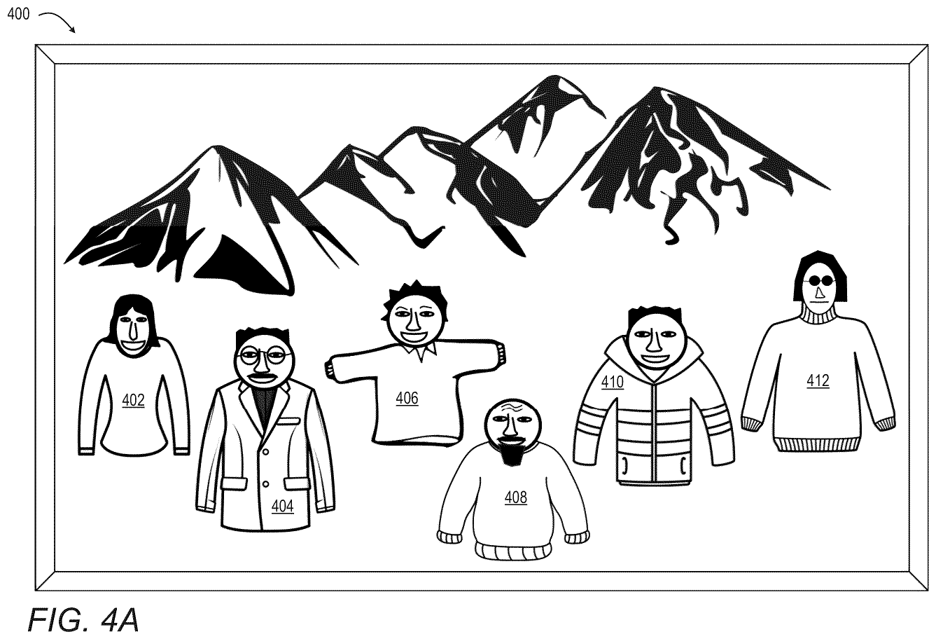

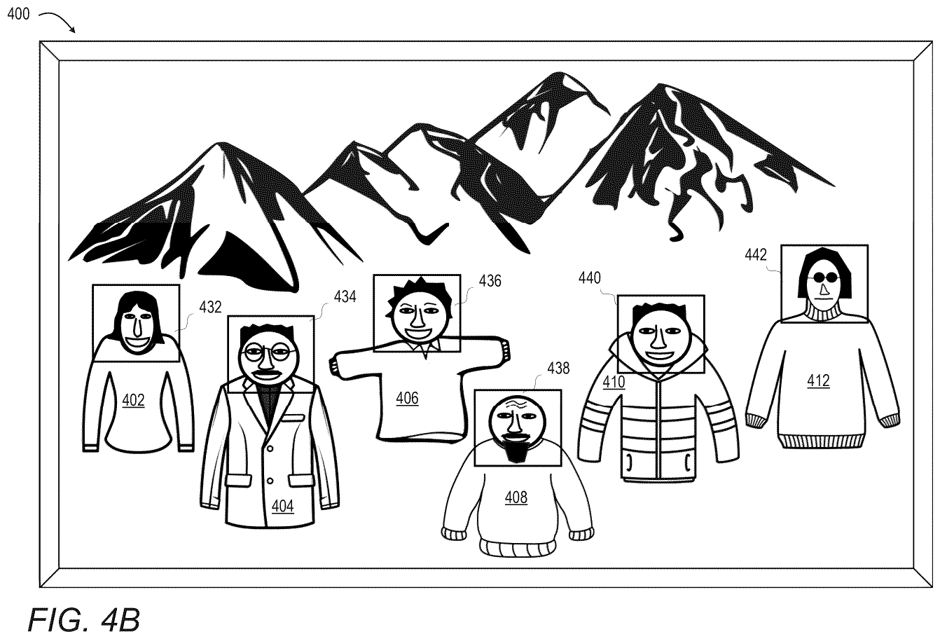

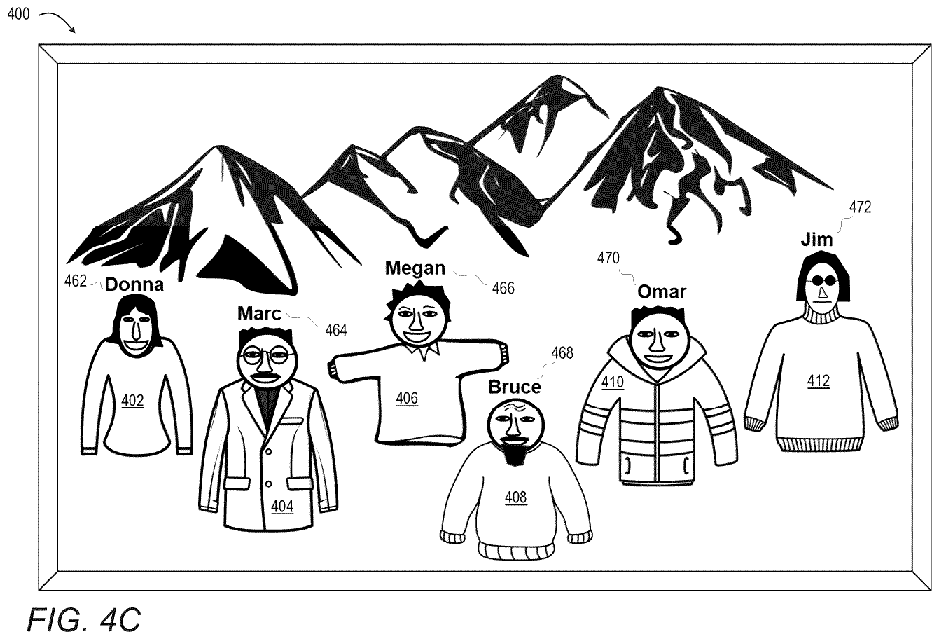

FIG. 4A depicts an exemplary image 400 used for creating an image-based group, according to one or more embodiments. The exemplary image 400 includes six people, indicated as 402, 404, 406, 408, 410, and 412. While six people are shown in image 400, other embodiments can support images with more or fewer people. FIG. 4B depicts the image of FIG. 4A, with facial bounding boxes applied around the face of each of the six people, according to one or more embodiments. In one or more embodiments, the obtained image from FIG. 4A may be preprocessed to enhance its quality and make it suitable for face detection algorithms. The preprocessing steps can include, but are not limited to, adjusting the brightness, contrast, and color balance of the image. One or more embodiments may include a face detection application (156 of FIG. 1) that utilizes a face detection algorithm to analyze the preprocessed image and identify regions that likely contain faces. One or more embodiments may utilize a Viola-Jones algorithm and/or a Haar-cascade classifier for detecting the faces. After the potential face regions are identified, the algorithm extracts features from the face regions, such as the position of the eyes, nose, and mouth, hair color, facial hair, as well as the overall shape and texture of the face. The electronic device then renders a bounding box around each detected face to highlight the face in the image. This bounding box can aid users in visualizing the location and size of each face in the image. As shown in FIG. 4B, bounding box 432 is rendered around the face of person 402, bounding box 434 is rendered around the face of person 404, bounding box 436 is rendered around the face of person 406, bounding box 438 is rendered around the face of person 408, bounding box 440 is rendered around the face of person 410, and bounding box 442 is rendered around the face of person 412. In one or more embodiments, the bounding boxes are rendered in a color such as yellow or orange, to enable the bounding boxes to be easily visible in most images.

FIG. 4C depicts the exemplary image of FIG. 4A that was used for image-based group creation with name tagging applied, according to one or more embodiments. In one or more embodiments, the name tagging process includes comparing the extracted features of each face region with a database of known faces to determine if there is a match. The database of known faces can include contact database 157 of FIG. 1 and/or one or more online databases, such as provided by social media systems and/or other online user directories. In one or more embodiments, protocols including, but not limited to, HTTP (Hypertext Transfer Protocol). RESTful APIs, SOAP (Simple Object Access Protocol), and/or WebSockets may be used for interfacing with online sources to obtain images and/or other metadata of people to compare with the identified faces. In one or more embodiments, the online databases may be stored on a server such as server 175 of FIG. 1. As shown in FIG. 4C, name tag 462 is rendered proximal to person 402, name tag 464 is rendered proximal to person 404, name tag 466 is rendered proximal to person 406, name tag 468 is rendered proximal to person 408, name tag 470 is rendered proximal to person 410, and name tag 472 is rendered proximal to person 412. In one or more embodiments, the name tags are rendered in a color such as yellow or orange, to enable the name tags to be easily visible in most images. Note that while FIG. 4C shows name tags without the bounding boxes that are depicted in FIG. 4B, in one or more embodiments, an image that combines bounding boxes and name tags may be rendered as part of the image-based group creation process.

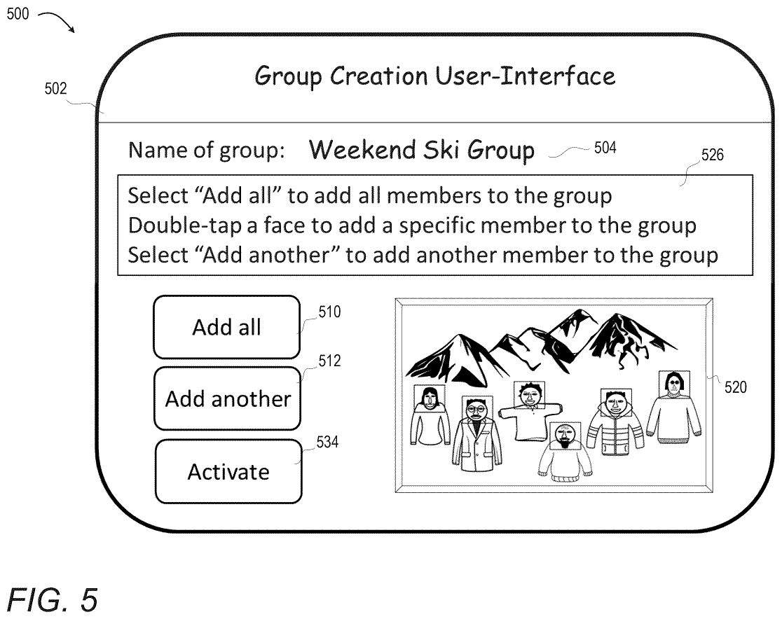

FIG. 5 illustrates an exemplary group creation user interface 500, according to one or more embodiments. In one or more embodiments, the user interface shown in FIG. 5 may be rendered on a display 502 of a device such as device 100 of FIG. 1. The user interface 500 includes the group name field 504, where the name of the group is shown. The user interface 500 includes a rendering of the group image 520. The user interface 500 may further include an add all button 510. The add all button 510, when invoked (e.g., via tap, click, etc.) causes a processor of the electronic device to add all identified persons in the group image 520 to the newly created group specified in field 504. Optionally, the user interface 500 can include an instruction field 526 to explain/provide additional options for adding group members. In one or more embodiments, instead of selecting the add all button 510, a user may opt to select individual faces from the group image 520. In one or more embodiments, the selecting can include tapping, double-tapping, and/or clicking of a face within the group image 520. In one or more embodiments, the user interface 500 supports double-tapping a face to add/remove a bounding box. By default, all recognized faces may have a bounding box. A user can double-tap one or more faces to deselect them and remove the bounding box. Then, the user can select the Add all button 510 to add only the people corresponding to the faces that have a bounding box around them. This feature provides a convenient way to form a group with a subset of people in an image, while excluding other people in the image. In one or more embodiments, one or more persons shown in the group image 520 may be added to the group via voice command. The voice command can include a format such as “add member” followed by the name of the member. As an example, a user can utter “add member Marc” to add person 404 of FIG. 4C to the group.

The user interface 500 may further include an add another button 512. The add another button 512, when invoked (e.g., via tap, click, etc.) causes a processor of the electronic device to add a different person to the group. The different person can include a person not included (or not recognized) in the group image 520. In this way, a user that is creating an online group retains complete control over the members that are included in the initial creation of the group. The group image 520 is used as a starting point for the group creation. However, the user that is creating the online group does not have to include each person shown in the group image 520. Moreover, the user that is creating the online group has the option to add, to the online group, other members that are not shown (or not recognized) in the group image. In one or more embodiments, the add another button 512 may provide an option to import another image for adding members to the group. In this way, multiple images can be easily obtained for use in creating an electronic online group.

The user interface 500 may further include an activate button 534. The activate button 534, when invoked (e.g., via tap, click, etc.) causes a processor of the electronic device to create and store the group on the electronic device, initiate the process to upload the group data to an online group repository maintained by a group management server, and then send an electronic communication to at least one other electronic device associated with each group member. The electronic communication can include instructions and/or hyperlinks for accessing a group registration portal.

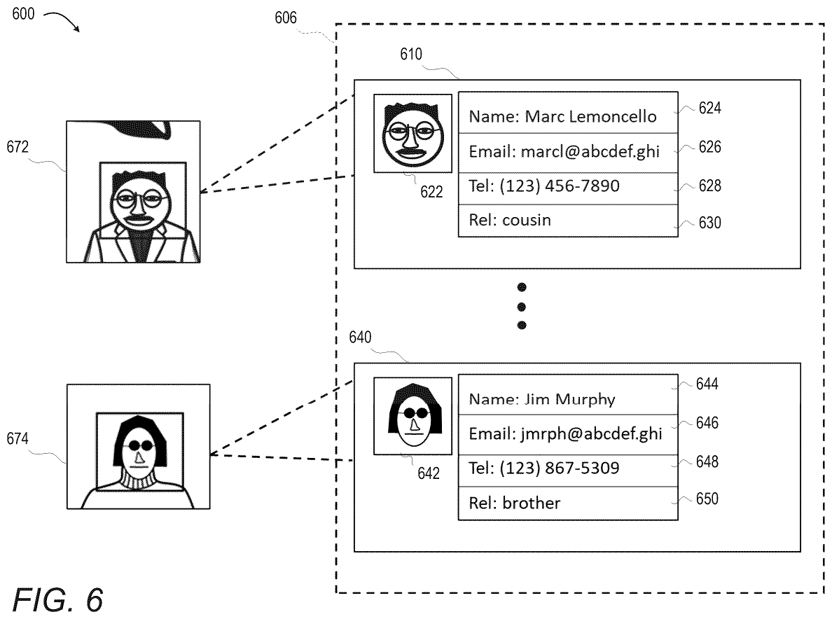

FIG. 6 shows an example 600 of exemplary group member data records for individuals within an electronically-created group, according to one or more embodiments. Database 606 includes face data, as well as additional metadata, for a plurality of people. While two data records are shown in the example 600 of FIG. 6, in practice, there can be many hundreds, or many thousands of such data records. Referring now to data record 610, there is included facial data 622, which can include one or more images of a person. In one or more embodiments, at least one of the one or more images includes a portrait image. Other images of the one or more images can include side profile images, full body images, and so on. The data record 610 can further include a name field 624. The name field 624 can include a full name of a person, and/or one or more aliases (nicknames) for the person. The data record 610 can further include an email address field 626. The email address field 626 can include one or more email addresses corresponding to the person. The data record 610 can further include a telephone number field 628. The telephone number field 628 can include one or more telephone numbers corresponding to the person's mobile communication device. The data record 610 can further include a relationship field 630. The relationship field can include one or more relationship descriptors for the person. The relationship descriptor(s) can describe the relationship of the person referenced in data record 610 to the person that is performing the group creation. As an example, the relationship field 630 includes a relationship descriptor of ‘cousin.’ Other relationship descriptors can include other family relationships. Relationship descriptors can also be used for non-family relationships. For example, relationship descriptors can include professional relationships, such as manager, vice president, director, and so on. Relationship descriptors can include team relationships, such as quarterback, wide receiver, linebacker, and so on. In one or more embodiments, the relationship descriptors can be used to specify a role for one or more persons included within an online group. In one or more embodiments, the creator of the group can edit the relationship field of a data record to add, delete, and/or modify relationship descriptors. Similar to data record 610, data record 640 includes facial data 642, name field 644, email field 646, telephone number field 648, and relationship field 650. Other embodiments may include more, fewer, and/or different fields than those depicted in example 600.

Example 600 shows image subregion 672. Image subregion 672 represents a portion of the image depicted in FIG. 4B that includes a face corresponding to person 404. One or more embodiments can use facial identification techniques to associate image subregion 672 with the facial data 622, and also associate the metadata from fields 624, 626, 628, and 630 with person 404. Similarly, image subregion 674 represents a portion of the image depicted in FIG. 4B that includes a face corresponding to person 412. Accordingly, in one or more embodiments, identifying each of the at least two people comprises: for each of the at least two people, matching a face from the image to a face associated with a stored contact. One or more embodiments can use facial identification techniques to associate image subregion 674 with the facial data 642 and also associate the metadata from fields 644, 646, 648, and 650 with person 412. In one or more embodiments, obtaining metadata for each identified person of the at least two people comprises: for each of the at least two people, obtaining at least one of a telephone number and an email address from the stored contact. The telephone number and/or email address can be used for sending group registration information to the group members.

In one or more embodiments, group entry criteria can be established during the group creation process. The group entry criteria can include information that is used to filter people based on metadata, such as relationship descriptors. As an example, a group for ‘cousins’ can be created, that can automatically include data record 610, which has a relationship field 630 that includes the relationship descriptor ‘cousin’ and automatically exclude data record 640, as the relationship field 650 does not include a relationship descriptor of ‘cousin.’ Thus, one or more embodiments can include adding persons from the plurality of persons to the group based on corresponding metadata for an added person satisfying the group entry criteria. In one or more embodiments, the creator of the group may be able to manually edit the metadata of the data records, including the relationship field. Thus, one or more embodiments can include adding the group role for each identified person to the metadata for the identified person. Accordingly, disclosed embodiments can perform effective automated image-based group creation, thereby streamlining the process of creating a new online group.

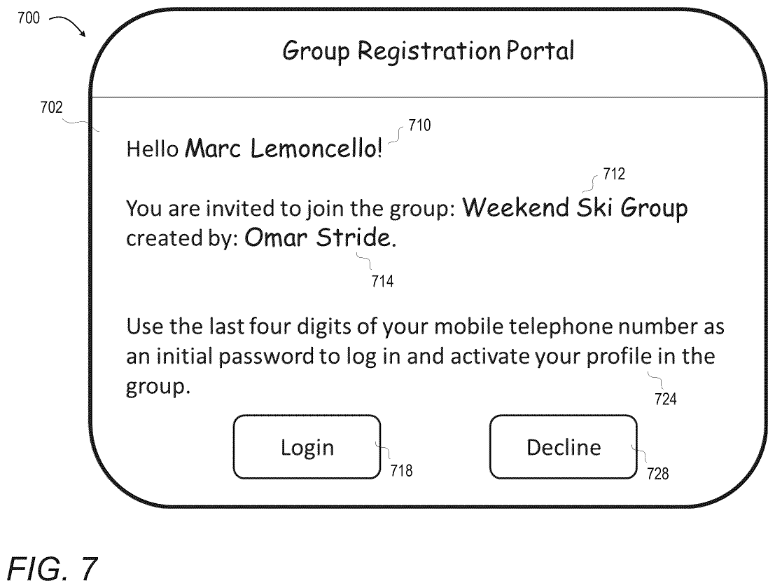

FIG. 7 illustrates an exemplary group registration portal user interface 700, according to one or more embodiments. In one or more embodiments, the user interface shown in FIG. 7 may be rendered on a display 702 of a device such as device 100 of FIG. 1. The user interface 700 includes a group member name field 710, where a name of a particular member of the group is displayed. The user interface 700 can further include a group name field 712, where a name of the newly created online group is displayed. The user interface 700 can further include a group creator name field 714, where a name of the person that created the online group is displayed. The user interface 700 may further include a login button 718. The login button 718, when invoked (e.g., via tap, click, etc.) causes a processor of the electronic device to enable the inputting of login credentials to allow the group member to activate his/her profile. As part of the activation process, the group member may be provided an opportunity to confirm, edit, and/or delete some or all of his/her information. Thus, one or more embodiments can include: displaying a confirmation user-interface for activating the group; activating the group in response to receiving a confirmation input via the group creation user-interface; and sending a notification providing access to the group registration portal to each member of the group, using the respective contact information. Thus, by using the login button 718, in one or more embodiments, the group creation user-interface can serve as a confirmation user-interface, confirming that the invited person has accepted the invitation to join the group.

The user interface 700 may further include a decline button 728. The decline button 728, when invoked (e.g., via tap, click, etc.) causes a processor of the electronic device to enable an invited group member to decline an invitation to a group without needing to activate the group membership. Thus, in one or more embodiments, the group member may be provided an opportunity to decline membership into the group. In one or more embodiments, a decline response may be sent to the group creator, indicating that the person declined to join the group. The user interface 700 can further include an instruction field 724, where instructions on how to login and/or perform group member activation may be shown. The instructions may include indicating information that is to be used as login credentials (e.g., the last four digits of a mobile telephone number). In one or more embodiments, a user's face may be used as a biometric login for authentication purposes to activate the group membership. The biometric login can be used instead of, or in addition to, other information such as the last four digits of a mobile telephone number. The processor of the electronic device, upon receiving the correct credentials and/or biometric information, can activate the group membership for the corresponding group member. The activation can include enabling the member to log into the group, send and receive messages within the group, receive group notifications, and/or other features.

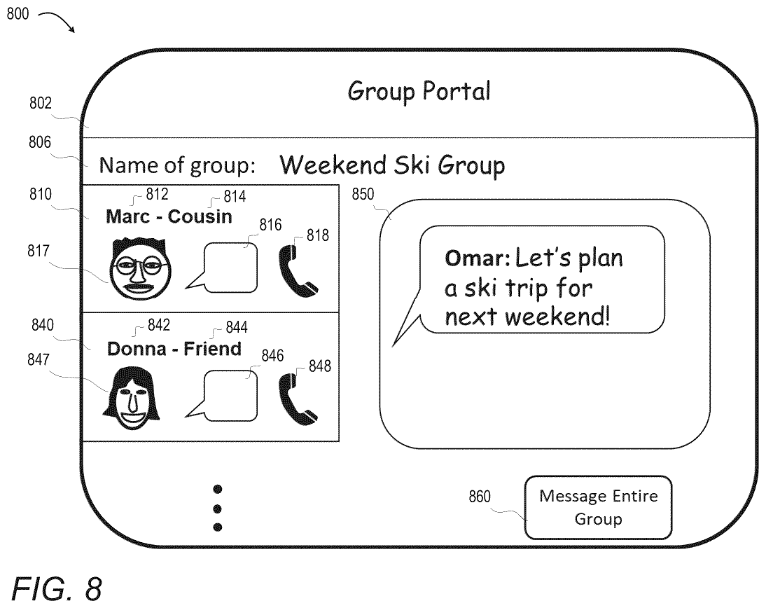

FIG. 8 illustrates an exemplary user interface 800 for intra-group communication, according to one or more embodiments. In one or more embodiments, the user interface shown in FIG. 8 may be rendered on a display 802 of a device such as device 100 of FIG. 1. The user interface 800 includes a group name field 806, where a name of the online group is shown. The user interface 800 can further include one or more group member records. As shown in the example of FIG. 8, two group member records, indicated at 810 and 840 are shown. In one or more embodiments, more than two group member records may be shown simultaneously on the display 802.

Group member record 810 can include a group member name field 812, and a group role field 814. In one or more embodiments, group member record 810 may further include a text chat button 816. The text chat button 816, when invoked (e.g., via tap, click, etc.), causes a processor of the electronic device to enable a user interface to compose and send a direct message to the group member referenced in group member record 810. In one or more embodiments, group member record 810 may further include a voice call button 818. The voice call button 818, when invoked (e.g., via tap, click, etc.) causes a processor of the electronic device to enable a user interface to initiate a voice call (e.g., via cellular service, or app-based voice call) to the group member referenced in group member record 810. Similarly, group member record 840 can include a group member name field 842, and a group role field 844, a text chat button 846, and a voice call button 848, each providing similar functionality as the feature with similar name within group member record 810. In one or more embodiments, group member record 810 can include a face image 817. The face image can be a cropped portion of an image used to create a group, or an image later updated by the group member. Similarly, in one or more embodiments, group member record 840 can include a face image 847.

In one or more embodiments, user interface 800 may further include a message group button 860. The message group button 860, when invoked (e.g., via tap, click, etc.) causes a processor of the electronic device to enable the sending of a group text message that is composed in message composition field 850, to each member of the group. Accordingly, disclosed embodiments can enable group-based communication, as well as direct message capabilities for communication between individual members of the group.

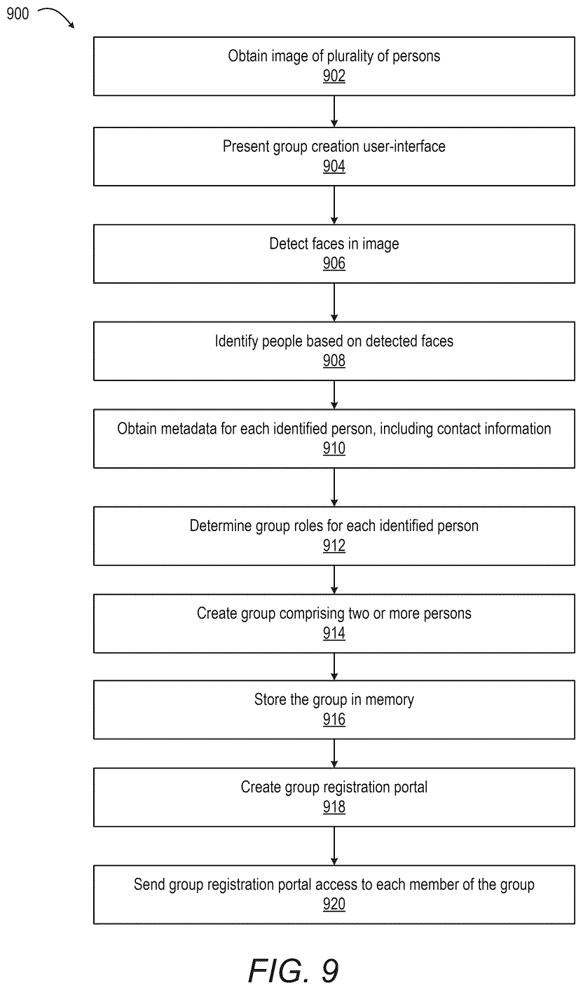

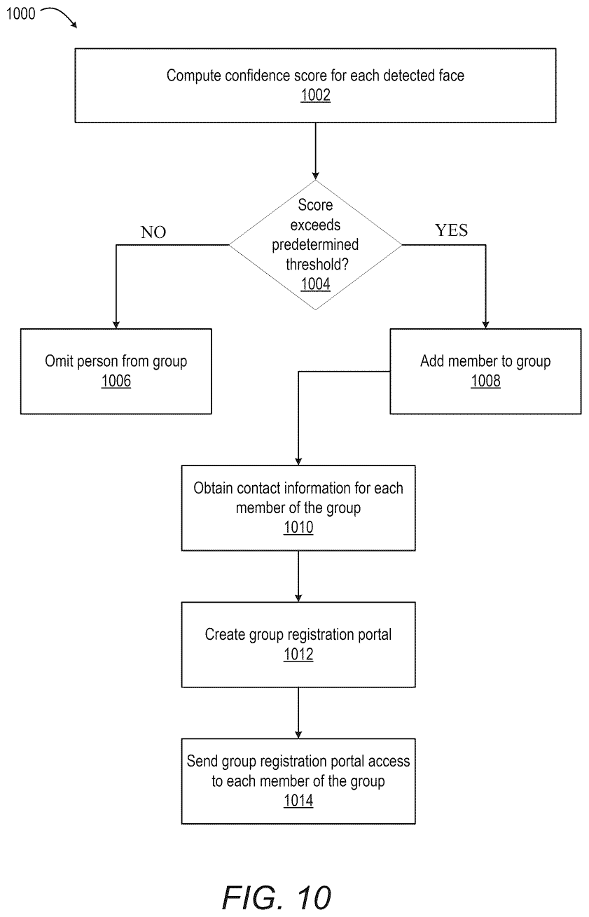

Referring now to the flowcharts presented by FIG. 9 and FIG. 10, the descriptions of the methods in by FIG. 9 and FIG. 10 are provided with general reference to the specific components and features illustrated within the preceding FIGS. 1-8. Specific components referenced in the methods of by FIG. 9 and FIG. 10 may be identical or similar to components of the same name used in describing preceding FIGS. 1-8. In one or more embodiments, processor 102 (FIG. 1) configures electronic device 100 (FIG. 1) to provide the described functionality of the methods of FIG. 9 and FIG. 10 by executing program code for one or more modules or applications provided within system memory 120 of electronic device 100, including IBGC module 152, Group app 154, and/or FD app 156 (FIG. 1).

FIG. 9 depicts a flowchart of a computer-implemented method 900 for image-based group creation, according to one or more embodiments. The method 900 starts at block 902, where an image of a plurality of persons is obtained. In one or more embodiments, the image can be obtained from a camera (image capture device) of an electronic device. In one or more embodiments, the image can be a previously taken image that is retrieved from a storage location. The storage location can include on-device storage or networked storage, such as from a cloud-based storage location. The method 900 continues to block 904, where a group creation user interface, such as depicted in FIG. 5, is autonomously generated and rendered on the display for presentation to a user that is creating the group.

The method 900 continues to block 906, where the processor or AI module detects faces in the image. The method 900 continues to block 908, where the processor or AI module identifies one or more people, based on the detected faces. In one or more embodiments, the identification can include using feature-based matching. The feature-based matching can include extracting key features from the faces in both the obtained photograph and the database photographs. These features can include the position of the eyes, nose, and mouth, as well as other facial landmarks. Matching is then done by comparing these features to those within the database of faces of known people to find similarities. The identification can include template matching. The template matching can include creating a template or reference image of the face in the obtained photograph. This template is then compared to the faces in the database to find the closest match based on similarity metrics. The identification can include machine-learning based matching. The machine-learning based matching can include the use of convolutional neural networks (CNNs). In one or more embodiments, the CNN is trained a priori on a large dataset of faces to learn features that are effective for matching. One or more embodiments may utilize other face matching techniques instead of, or in addition to, the aforementioned identification techniques.

The method 900 continues to block 910, where metadata for each identified person is obtained. The metadata can include contact information. The contact information can include telephone numbers, email addresses, user identifiers, street addresses, and/or other contact information. The metadata can further include one or more relationship descriptors. The relationship descriptors can include personal relationship descriptors, such as spouse, friend, brother, cousin, etc. The relationship descriptors can include other relationships, such as professional roles/positions, team roles/positions, and/or other types of relationship information. The method 900 continues to block 912, where group roles are determined for each identified person, based on one or more of their corresponding relationship descriptors. The method 900 continues with creating a group comprising two or more persons at block 914. The creating of the group can include allocating and/or initializing one or more data structures in memory on the electronic device and/or memory in a remote storage location, such as cloud-based storage. The data structures can include a relational database, a linked list, and array of structures, and/or other suitable data structures. The method 900 continues to block 916, where the allocated and initialized data structures are stored in memory. In one or more embodiments, the memory can include nonvolatile memory on the electronic device, such as nonvolatile RAM, flash memory, and/or other suitable type of memory. The method 900 continues to block 918, where a group registration portal, such as depicted at FIG. 7, is created. The method 900 then continues with sending group registration portal access to each member of the group at block 920. In one or more embodiments, access to the group registration portal can be accomplished by sending a link to the group registration portal to each member of the group.

One or more embodiments provide a method for image-based group creation that includes: obtaining, by a processor of an electronic device comprising a display, an image comprising a plurality of persons; presenting a group creation user-interface on the display, wherein the group creation user-interface enables specifying group entry criteria; detecting a face for at least two people among the plurality of persons; identifying each of the at least two people, based on the detected face; obtaining metadata for each identified person of the at least two people, where the metadata includes contact information; determining a group role for each identified person, in part based on the metadata obtained for the identified person; creating a group comprising two or more persons from the plurality of persons and assigning a corresponding group role to each of the at least two people identified; storing the group in memory of the electronic device; and creating a group registration portal to enable the members added to the group to access and utilize the group.

FIG. 10 depicts a flowchart of a computer-implemented method 1000 for autonomously selecting group members to complete image-based group creation, according to one or more embodiments. The method 1000 starts at block 1002, where a confidence score is computed for each face that was acquired as part of obtaining an image from a camera or stored album. In one or more embodiments, computing the confidence score can include performing feature matching and computing the similarity between the features, using metrics such as Euclidean distance and/or cosine similarity. In one or more embodiments, a lower Euclidean distance and/or higher cosine similarity indicates a higher confidence score. The method 1000 continues to block 1004, where a check is made to determine if the confidence score exceeds a predetermined threshold. If the score exceeds the predetermined threshold at block 1004, then the method 1000 continues to block 1008, where the member is added to the group. The method 1000 then continues to block 1010, where contact information for the group members is obtained. The method 1000 then continues to block 1012 for creating the group registration portal, such as depicted at FIG. 7. The method 1000 then continues with sending group registration portal access to each member of the group at block 1014. In one or more embodiments, access to the group registration portal can be accomplished by sending a link to the group registration portal to each member of the group. If, at block 1004, it is determined that the confidence score does not exceed the predetermined threshold, then the method 1000 continues to block 1006, where the person is omitted from (not included in) the group. One or more embodiments can include: computing a confidence score for each detected face among the plurality of persons; and creating the group to include each person corresponding to a detected face having a confidence score exceeding a predetermined threshold. Thus, in cases where a person is not adequately identified, the person can be automatically excluded from the group. In such situations, a group creator may manually add the person, such as by using the add another button (512 of FIG. 5). Accordingly, disclosed embodiments provide convenient image-based online group creation, while still providing flexibility for customizing the membership of the group.

As can now be appreciated, disclosed embodiments provide techniques for image-based group creation that can streamline the process of creating an online group, reducing the time and effort required to set up the group and invite members. Moreover, disclosed embodiments can be used to create online groups with specific features and functionalities tailored to the needs of the group members, such as the establishment of group roles. Thus, disclosed embodiments can serve to enhance communication, collaboration, and community building, benefiting both group creators and group members.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device, including a display;
a communication system;
a memory having stored thereon an image-based group creation (IBGC) module; and
at least one processor communicatively coupled to the display, the communication system, and the memory, wherein the at least one processor executes program code of the IBGC module, and configures the electronic device to:
present a group creation user-interface on the display, wherein the group creation user-interface enables specifying group entry criteria;
obtain an image comprising a plurality of persons;
detect a face for at least two people among the plurality of persons;
identify each of the at least two people, based on the detected face;
obtain metadata for each identified person of the at least two people, wherein the metadata includes contact information;
determine a group role for each identified person, in part based on the metadata obtained for the identified person;
create a group comprising two or more persons from the plurality of persons and assigning a corresponding group role to each of the at least two people identified;
store the group in the memory of the electronic device; and
create a group registration portal.

2. The electronic device of claim 1, wherein further the at least one processor:
computes a confidence score for each detected face among the plurality of persons; and
creates the group to include each person corresponding to a detected face having a confidence score exceeding a predetermined threshold.

3. The electronic device of claim 1, further comprising an image capture device, and wherein to obtain the image, the at least one processor obtains the image from the image capture device.

4. The electronic device of claim 1, wherein to obtain the image, the at least one processor obtains the image from a storage location that contains previously acquired images.

5. The electronic device of claim 1, wherein further the at least one processor:
displays a confirmation user-interface for activating the group;
activates the group in response to receiving a confirmation input via the group creation user-interface; and
sends, to each member of the group, via the communication system, a notification providing access to the group registration portal, using the contact information.

6. The electronic device of claim 1, wherein further the at least one processor adds persons from the plurality of persons to the group based on corresponding metadata for an added person satisfying the group entry criteria.

7. The electronic device of claim 1, wherein further the at least one processor adds the group role for each identified person to the metadata for the identified person.

8. The electronic device of claim 1, wherein to identify each of the at least two people, the at least one processor:
for each of the at least two people, matches a face from the image to a face associated with a stored contact.

9. The electronic device of claim 8, wherein to obtain metadata for each identified person of the at least two people, the at least one processor:
for each of the at least two people, obtains at least one of a telephone number and an email address from the stored contact.

10. A method comprising:
obtaining, by a processor of an electronic device comprising a display, an image comprising a plurality of persons;
presenting a group creation user-interface on the display, wherein the group creation user-interface enables specifying group entry criteria;
detecting a face for at least two people among the plurality of persons;
identifying each of the at least two people, based on the detected face;
obtaining metadata for each identified person of the at least two people, wherein the metadata includes contact information;
determining a group role for each identified person, in part based on the metadata obtained for the identified person;
creating a group comprising two or more persons from the plurality of persons and assigning a corresponding group role to each of the at least two people identified;
storing the group in memory of the electronic device; and
creating a group registration portal.

11. The method of claim 10, further comprising:
computing a confidence score for each detected face among the plurality of persons; and
creating the group to include each person corresponding to a detected face having a confidence score exceeding a predetermined threshold.

12. The method of claim 10, further comprising:
displaying a confirmation user-interface for activating the group;
activating the group in response to receiving a confirmation input via the group creation user-interface; and
sending to each member of the group, a notification providing access to the group registration portal, using the contact information.

13. The method of claim 10, further comprising adding persons from the plurality of persons to the group based on corresponding metadata for an added person satisfying the group entry criteria.

14. The method of claim 10, further comprising adding the group role for each identified person to the metadata for the identified person.

15. The method of claim 10, wherein identifying each of the at least two people comprises:
for each of the at least two people, matching a face from the image to a face associated with a stored contact.

16. The method of claim 15, wherein obtaining metadata for each identified person of the at least two people comprises:
for each of the at least two people, obtaining at least one of a telephone number and an email address from the stored contact.

17. The method of claim 10, wherein obtaining the image comprises obtaining the image from an image capture device.

18. The method of claim 10, wherein obtaining the image comprises obtaining the image from a storage location on the electronic device that contains previously acquired images.

19. A computer program product comprising a non-transitory computer readable medium having program instructions that when executed by a processor of an electronic device comprising a display, configure the electronic device to perform functions comprising:
obtaining an image comprising a plurality of persons;
presenting a group creation user-interface on the display, wherein the group creation user-interface enables specifying group entry criteria;
detecting a face for at least two people among the plurality of persons;
identifying each of the at least two people, based on the detected face;
obtaining metadata for each identified person of the at least two people, wherein the metadata includes contact information;
determining a group role for each identified person, in part based on the metadata obtained for the identified person;
creating a group comprising two or more persons from the plurality of persons and assigning a corresponding group role to each of the at least two people identified;
storing the group in memory of the electronic device; and
creating a group registration portal.

20. The computer program product of claim 19, further comprising program instructions for:
displaying a confirmation user-interface for activating the group;
activating the group in response to receiving a confirmation input via the group creation user-interface; and
sending to each member of the group, a notification providing access to the group registration portal, using the contact information.
